(19) United States
(12) Patent Application Publication
(10) Pub. No.: US 2007/0285867 A1
(43) Pub. Date: Dec. 13, 2007

(54) High resistance current limiting fuse, methods, and systems

(75) Inventor: Frank John Muench, Waukesha, WI (US)

Correspondence Address: KING & SPALDING LLP, 1180 PEACHTREE STREET, ATLANTA, GA, 30309-3521, US

(73) Assignee: Cooper Technologies Company

(21) Appl. No.: 11/451,666

(22) Filed: Jun. 13, 2006

(51) Int. Cl. H01H 47/32; H01H 47/00

(52) U.S. Cl. 361/159

(57) ABSTRACT

A current limiting fuse with a resistance element connected in series with a currently limiting fuse element, and systems and methods therefore.

### BACKGROUND OF THE INVENTION

This invention relates generally to overcurrent protection fuses, and, more particularly, to current limiting fuses.

Electrical transmission and distribution networks include a large number of transformers, capacitor banks, reactors, motors, generators and other major pieces of electrical equipment. Such equipment is expensive, and each piece of equipment typically plays a vital role in the distribution of power to end users, such that an outage caused by the equipment being damaged or taken out of service for repair or replacement, may have costly consequences. As a result, such equipment is typically protected from potentially damaging overvoltages and overcurrents by protective components, such as fuses and surge arresters.

Certain types of electrical fuses, referred to as current limiting fuses, include fuse elements that are constructed to be fully responsive to open a circuit in any of a variety of current values within a predetermined range of current conditions. Also, the fuse elements of current limiting fuses are fast acting to clear faults in less than one cycle of AC power frequency, while limiting let-through current to protect downstream equipment from damage. Conventional current limiting fuses, however, are disadvantaged for certain installations.

### BRIEF DESCRIPTION OF THE DRAWINGS

FIG. 1 is a sectional schematic of a first embodiment of a current limiting fuse according to the present invention.

FIG. 2 is a sectional schematic of a second embodiment of a current limiting fuse according to the present invention.

FIG. 3 illustrates an exemplary electrical system utilizing the current limiting fuses according to the present invention.

### DETAILED DESCRIPTION OF THE INVENTION

Current-limiting fuses are desirable for power utility companies for several reasons. For example, interruption of overcurrents may be accomplished quickly and without expulsion of flaming arc products or gases or the development of forces external to the fuse body, all of which are characteristic of expulsion type fuses. This enables the current-limiting fuse to be used indoors, or even in small enclosures. Furthermore, since there is no discharge of hot gases or flame, only normal electrical clearances from other apparatus need to be provided. With weather resistant coatings, these fuses may also be used outdoors.

Additionally, when an overcurrent greatly exceeds the continuous current rating of the fuse, the fuse provides a current-limiting action or reduction of current through the fuse to a value less than that otherwise available from the power-distribution network at the fuse location. Such a current reduction reduces the stresses and possible damage to the circuit up to the fault or to the faulted equipment itself, and also reduces the shock to the distribution network.

Finally, very high interrupting ratings may be achieved by virtue of the current-limiting action of the fuse so that current-limiting fuses can be applied on medium or high-voltage distribution circuits of very high available short-circuit currents.

While known current limiting fuses have enjoyed some success in protecting medium and high power distribution circuits, the performance of conventional fuse constructions is not suitable for certain installations. One exemplary installation wherein conventional fuses have been found inadequate is a power line carrier communications system 100 wherein signals of a particularly frequency are transmitted over power lines. Such systems 100 may be used, among other things, to establish broadband connections between networked devices.

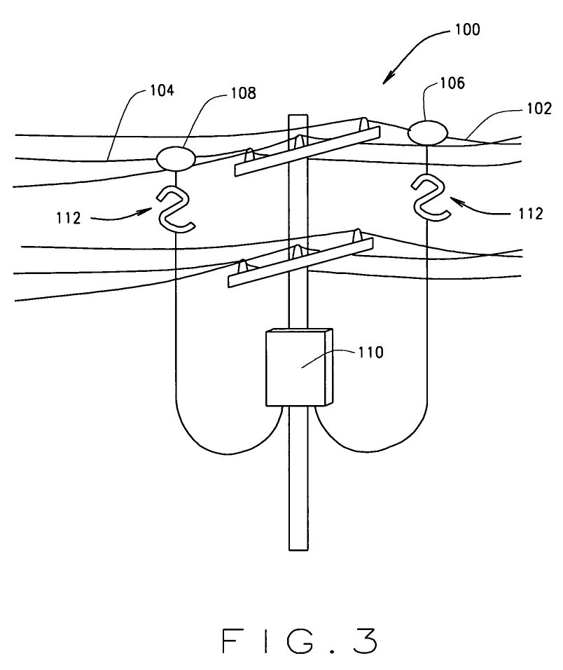

As shown in FIG. 3, the system 100 may include high voltage power lines 102, 104 connected to a high voltage electrical power grid in a known manner, and specialized couplings 106, 108 connected to the power lines 102, 104 to provide for the transmission of digital data over the high voltage electrical power grid via the conductors 102, 104. A low voltage digital communications device 110 is connected to the high voltage power lines 102, 104 via the couplings 106, 108, and current limiting fuse devices 112 are connected between the communications device 110 and each coupling 106 and 108 to protect the communications device 110 from damaging currents. The communications device 110 is powered by a low voltage power supply and communicates with computers and electronic devices to receive and transmit digital data over the power lines 102 and 104 in a known manner. The communications device 110, the couplings 106 and 108, and operation of the communications device 110 to send and transmit data over the power lines 102, 104 are known and not discussed in further detail herein as they are believed to be beyond the scope of the present invention.

In normal operation of the system 100, the fuse devices 112 experience almost no load current. Even though there is very little load current for each fuse 112, if either of the couplings 106 and 108 were to fail problems could occur on both the electrical power grid and on a power supply to the low voltage digital data communications device 110. If either coupling 106, 108 fails, with low impedance common to existing fuses used in the devices 112, a resulting very high current, which could be for example 10,000 amperes or more, would damage the cables, wires, transformers and other equipment making up the grid. On the other hand if the failure of a coupling 106 and 108 causes system voltage of about 2400 volts or more in one example to be placed on the utility customers' low voltage connections to the grid, the high voltage could result in significant damage to data systems, residences and other electrical equipment associated with the customers that are fed from a normally low voltage, such as a 120 or 240 volt system. In these cases current limiting fuses in the devices 112 can provide the best known protection.

However, the data coupling application in the system 100 is believed to be unique in that there is very low current associated with the digital data transmission. The couplings 106 and 108 are often mounted to a cable that is attached in parallel to the main conductor. Since typical current limiting fuses for the devices 112 have an impedance that is very low, on the order of 0.1Ω or less, they do not provide a way to block circulating currents, surges or other transient currents from passing through a wire section associated with the digital communications device 110. To block these currents, it is desirable to provide a current limiting fuse with a resistance that is higher than known current limiting fuses, in the range of 0.5 to more than 2Ω in one example. This forms a current divider so that the preferred path to normal load current remains through the main conductor, rather than passing through the coupling connection.

In order to accomplish the creation of a fuse that has a resistance value in this range a new design concept is required. Existing current limiting fuses are not intended to provide the level of resistance.

Developing new current limiting fuse elements for such applications may be possible, but is expensive. A lower cost alternative would be desirable.

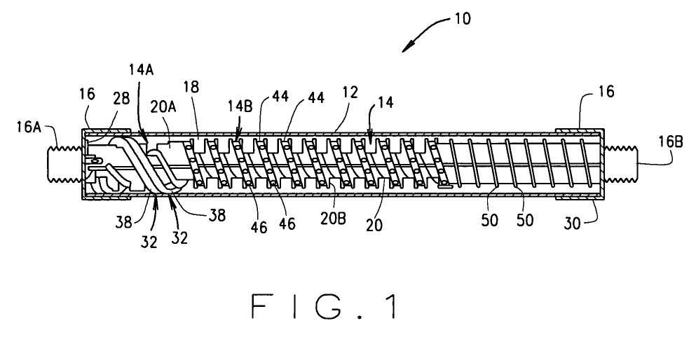

FIG. 1 illustrates a first embodiment of a high resistance current limiting fuse 10 according to the invention that more capably performs in environments, such as in the system 100 requiring additional resistance than conventional current limiting fuses may provide. The fuse 10 includes an insulative fuse body 12, a fuse element assembly 14 within body 12, electrically conductive end-caps 16 coupled to and enclosing body 12 and electrically connected to fuse element assembly 14, and an arc quenching material 18 surrounding fuse element assembly 14 within body 12.

As those in the art will appreciate, the fuse 10 is configured as a General Purpose or Full-Range type current-limiting fuse that is operable to safely interrupt both relatively high fault currents and relatively low fault currents with equal effectiveness. As such, a fuse element assembly 14 having two distinct portions is utilized. A low current interrupting portion 14A is configured for opening of an electrical circuit under relatively low fault current conditions and a high current interrupting portion 14B is configured for opening of an electrical circuit under relatively high fault current conditions as explained below. This combination creates a full range fuse element may interrupt any current that melts one or the other of the high and low current interrupting portions 14A and 14B, thereby providing protection against both low and high impedance faults.

The body 12 may be fabricated from a known insulative or non-conductive material and highly temperature resistant materials, such as known ceramic and plastic materials, and extends substantially cylindrically between end-caps 16. The tubular body 12 is dimensioned to receive and enclose the fuse element assembly 14. While a cylindrical body is shown in FIG. 1, it is understood that other shapes of the body 12 may likewise be employed, including but not limited to square or rectangular bodies if desired.

The arc extinguishing medium 18 may be granular pure silica sand or powdered quartz that completely surrounds the fuse element assembly 14 and substantially eliminates air gaps around the fuse element assembly 14 within the body 12. Other known arc extinguishing materials and mediums may be employed in fuse 10 in lieu of pure silica sand or powdered quartz.

The fuse element assembly 14 may include an insulated form 20 extending between the end caps 16, and the form 20 may include distinct portions 20A and 20B corresponding to the low current interruption portion 14A and the high current interrupting portions 14B, respectively. The form 20, also known as a spider or winding support may be fabricated as a monolithic piece or may alternatively be include multiple pieces joined together. The form 20 may include circumferential slots and spacing features for the current limiting fuse elements described below in each of the low and high current interrupting portions 14A, 14B of the fuse element assembly. While the form 20 is generally cylindrical in an illustrative embodiment, alternative shapes, i.e., non cylindrical shapes, of the form 20, including but not limited to elliptical cross-sectional shapes, polygonal, ribbed or star cross-sectional shapes may likewise be employed.

Electrically conductive terminal elements or connectors 28, 30 are oppositely coupled to form 20 at either end thereof. Each connector 28, 30 may include extensions that establish electrical contact with end-caps 16. Thus, an electrical circuit may be established through fuse elements, explained further below, that are wound about form 20 and electrically coupled to connectors 28, 30.

The end caps 16 include terminal stud connectors 16A and 16B at opposing ends of the fuse 10. The terminal stud connectors 16A and 16B provide connection points to the power distribution circuit. While terminal stud connectors are illustrated in FIG. 1, it is appreciated that a variety of alternative terminal elements are known in the art and may be used in lieu of the terminal studs, including but not limited to, blade contacts. In another embodiment, the terminal stud connectors 16A and 16B may be omitted and connections to circuitry may be made to the end caps 16 or ferrules via fuse clips and the like known in the art.

When the terminal stud connectors 16A and 16B are connected to an energized electrical circuit (not shown), a circuit is completed through the fuse 10 via fuse element assembly 14. When current flowing through the fuse 10 approaches unacceptable levels, dependent upon characteristics of fuse element assembly 14 and hence the current rating of fuse 10, the fuse element assembly 14 at least partially operates, melts, vaporizes or otherwise opens, as explained more fully below, to limit current flow and interrupt damaging current flow through fuse 10. Thus, line-side electrical circuits and equipment may be electrically isolated from malfunctioning load-side electrical circuits and equipment to prevent costly damage to the load and line-side circuits and equipment.

More specifically, the low current interrupting portion 14A includes a plurality of low current interrupting fuse elements 32 wound about the form portion 20A. The low current interrupting fuse elements 32 are connected in parallel to the connector 28, and the fuse elements 32 extend longitudinally from connector 28 toward the connector 30 in a helical fashion on the form portion 20A. In accordance with conventional current limiting fuse elements, each low current interrupting fuse element 32 is typically fabricated from silver, although other metals and alloys may alternatively be employed. Optionally, each low current interrupting fuse element 32 may be at least partially coated with an overlay 34 of a conductive metal that is different from a composition of fuse element 32 to produce an M effect as is known in the art and to modify operation of the fuse elements 32 if desired. This element may also contact a silver or copper wire, joined by a solder or other relatively low, 125° to 255° C. melting temperature alloy to control opening on low current faults or extended overloads.

It should be noted that the low current interrupting fuse elements 32 can be formed according to other known methods and techniques known in the art, such as, for example, covering holes or reduced sections in the fuse elements 32.

Each low current interrupting fuse element 32 may be encased in a flexible thermally insulative sleeve 38 of slightly greater dimension than a width of each fuse element 32. The insulative sleeves 38 may be fabricated from a material, such as silicon rubber, that is capable of withstanding high temperatures when fuse 10 is operated and also has a sufficient electrical resistance for insulative purposes. As the fuse element 32 opens near the weak spots, an electrical arc is generated across the break in the weak spot within the sleeve 38. The resultant blast of ionized gas may be expelled from sleeve 38 and harmlessly dissipated in the arc extinguishing medium 18 surrounding the fuse element assembly 14. Reinforcement features (not shown) may further be provided in combination with the sleeves 38 if desired.

A plurality of high current limiting current fuse elements 44 may also wound around the form portion 20B and are electrically connected to the respective low current interrupting elements 32. Each high current limiting fuse element 44 may be fabricated from a strip or ribbon of relatively high-melting point material, such as silver or other metal or alloy, and extends in a helical fashion from one end of the form portion 20B adjacent the portion 20A to the other end of the form portion 20B. Each high current limiting fuse element 44 is connected in parallel and includes a plurality of weak spots 46 formed by openings in the elements 44 to provide a reduced cross sectional area located at spaced intervals between along the axial length of the elements 44. It will be appreciated by those in the art that weak spots 46 could alternatively be formed according to other methods and techniques known in the art, such as, for example, forming necked or narrowed regions in the fuse elements 44 rather than the openings illustrated in FIG. 1.

Each high current limiting fuse element 44 may be coupled to a respective one of low current interrupting fuse elements 32 to form a plurality of continuously extending fuse elements that are partly high current limiting fuse elements 24 and partly low current interrupting fuse elements 32. The continuously extending fuse elements are wound about form 22 in a helical fashion and are connected in parallel with one another between connectors 28, 30.

In an alternative embodiment, low current interrupting fuse elements 32 and high current limiting fuse elements 44 may be connected to an interconnector member (not shown) disposed between low current interrupting fuse elements 32 and high current limiting fuse elements 24. As such, different numbers of low current interrupting fuse elements 32 relative to high current limiting fuse elements 44 may be employed to vary voltage and current ratings of fuse 10. As will be appreciated by those in the art, actual voltage and current ratings of fuse 10 may be further manipulated by altering dimensional characteristics of low current interrupting fuse elements 32 and high current limiting fuse elements 44.

While multiple fuse elements connected in parallel are illustrated in FIG. 1, it is contemplated that the benefits of the invention could be achieved at lower fuse ratings using a single low current interrupting element 32 and a single high current limiting element 44. Still further, in alternative embodiments, fuse one or more fuse elements 32, 34 may be electrically connected to end-caps 16 without being helically wound about form 20, such as for example, by employing substantially linear fuse elements between end-caps 16, with or without form 20. Bent or non-linear fuse elements may also be employed to increase the effective length of the fuse elements between the end caps 16 without increasing the axial length of the fuse 10.

There is a well known thermodynamic balance between the high current interrupting fuse elements 44 and the low current interrupting elements 32. Since the low current interrupting elements 32 have a much lower melt temperature than the high current interrupting elements 44, they open on long term low currents, from tens to hundreds of amperes for example. The low current interrupting elements 32 have a large mass and short term heat capacity, so that typically the high current interrupting elements 44 open first on high currents, causing circuit interruption, before the low current interrupting elements 32 open.

Resistance elements 50 may be separately provided from the fuse elements and connected in series with each end of each of the high current interrupting elements 44 opposite the low current interrupting elements 32. As such, current paths through the fuse 10 between the end caps 16 are defined by at least one the low current fuse elements 32, at least one of the high current fuse elements 44, and at least one of the resistance elements 50. The entire path across the elements 32, 44 and 50 is situated in the interior of the fuse body 12 and is protected by the body 12. An interconnector member (not shown) may be provided to interconnect the high current fuse elements 44 and the resistance elements 50, and the number of resistance elements 50 may be same or different from the number of the high current fuse elements 50.

In an exemplary embodiment, each resistance element 50 may be fabricated from a different material than the high and low current interrupting elements 32, 44 and has a greater electrical resistance than the current interrupting elements 32, 44. For example, the resistance element 50 may include a length of wire fabricated from a high resistance metallic element, such as nichrome, while the current interrupting elements 32, 44 are fabricated from a material having a comparatively lower resistance, such as silver. It is contemplated, however, that other materials may likewise be employed in alternative embodiments.

The dimensional size (i.e., the cross sectional area) of the resistance element 50 may be selected to provide an optimal resistance for the combination of the resistance element 50 and the current limiting elements 32, 44. As such, it may be ensured that the resistance element 50 and the current limiting elements 32, 44 do not interfere with one another in actual operation of the fuse 10. Selection of the resistance element 50 is influenced primarily by the electrical properties (e.g., resistivity) of the material used to fabricate the resistance element 50 in relation to the fabrication material of the current limiting elements 32, 44, and the geometric properties (e.g., shape, thickness, length, etc.) of the resistance element 50.

The geometric properties of the resistance element 50 may be selected and the resistance element 50 may be physically constructed to prevent the resistance element 50 from melting, disintegrating, or otherwise structurally failing before the current limiting elements 32, 44 open the circuit through the fuse. Likewise, the resistance element 50 should not substantially advance or delay the opening of the current limiting elements 32, 44. In different embodiments, the resistance element 50 may open at approximately the same time as the current limiting elements 32, 44, or alternatively the resistance element 50 may be selected to withstand currents that cause the current limiting elements 32, 44 to open.

In an exemplary embodiment the resistance element 50 is fabricated or otherwise formed into an axial length of resistance element having a substantially constant cross sectional area, as opposed to the current limiting elements 32, 44 having a varying or discontinuous cross sectional area along their axial length where the weak spots are located. Alternatively, the resistance element 50 may be fabricated with a varying or discontinuous cross sectional area if desired. In one example, the resistance element 50 is a cylindrical wire conductor, although it is appreciated that other shapes of conductors may be employed, including but not limited to flat and rectangular ribbon conductors or strips. Additionally, while a straight wire with the proper properties may be used, the length of resistance wire may instead be wound, coiled or helically extended around the form 20 as shown in FIG. 1 to extend its length while minimizing space for it within the fuse body 12. Further, bent or non-linear strips may be utilized for the resistance elements 50 to increase the effective length of the resistance elements 50 without having to increase the length of the fuse.

In an illustrative embodiment, the fuse 10 has an effective resistance of 10-20 times the maximum typical resistance of a conventional current limiting fuse of about 0.1 ohms. The added resistance of the element 50 causes the fuse 10 to work as a current divider on an application where the normal current is very low (e.g., less than one amp for example), but could rise to more than ten thousand amperes, for example, should the equipment it is protecting fails.

It should be understood that the added resistance introduced by the resistance element 50 tends to increase a peak arc voltage as the current limiting elements 32, 44 open to interrupt current flow through the fuse 10. The amount of resistance in the resistance element 50 should therefore be selected to ensure that the arc voltage does not reach levels sufficiently high to damage associated equipment connected to the fuse 10 on a electric power distribution network.

The fuse 10 operates as follows. During low overcurrent conditions, the high current limiting fuse elements 44 and the resistance elements 50 are cooled by the arc extinguishing medium 18 and the low current interrupting fuse elements 32 are heated to a sufficient level to cause them to open. Low pressure ionized gas from resultant arcs is expelled from sleeves 38 into the arc quenching medium.

At intermediate values of overload current (i.e., values between the low current interrupting rating and the high current interrupting rating) opening of fuse elements 32 at weak spot 36 and opening of fuse elements 44 at weak spots 46 occurs substantially simultaneously. The low current interrupting elements 32 and the high current interrupting elements 44 would be expected to open before the resistance elements 50 melt, although in some embodiments the resistance elements 50 would open when exposed to certain circuit conditions.

Under high fault current conditions, the high current interrupting elements 44 partially vaporize, and the arc extinguishing material absorbs energy and attains a high electrical resistance to safely and effectively interrupt current through the fuse. Again, depending on the configuration of the resistance elements 50, they may or may not open in overcurrent conditions sufficient to cause the fuse elements 32, 44 to open, although optimally the resistance element 50 would be unopened.

The resistance elements 50 may be added at low cost and without redesigning the operative portions 14A and 14B of the fuse assembly 14. That is, a substantially conventional fuse element assembly may be utilized, and by introducing the resistance elements 50 in series with the fuse element assembly, the fuse 10 may capably perform in environments in which the fuse assembly is otherwise incapable of properly performing.

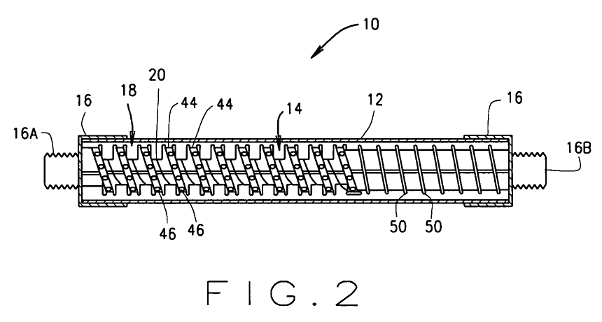

FIG. 2 is a sectional schematic of a second embodiment of a fuse 60 wherein common features with fuse 10 (shown in FIG. 1) are indicated with like reference characters. Unlike the fuse 10 wherein the fuse element assembly is configured as a full range fuse, the fuse 60 includes a fuse element configured as a backup fuse. That is the fuse element in the fuse 60 does not include the low current interrupting fuse links shown in FIG. 1. When configured as a backup fuse, fault currents that are typically two or more times the current carrying rating of the current limiting elements fuse may interrupted. If low overcurrent interruption is desirable, the fuse 60 may be connected in series with another device, such as another fuse, to configured to interrupt current accordingly.

Except as otherwise noted, the fuse 60 provides substantially similar benefits to the fuse 10, and further description thereof is deemed unnecessary. The fuse 60, like the fuse 10, may capably perform in installations requiring higher resistance than conventional current limiting fuses may provide, such as the in the system 100 of FIG. 3. That is, the fuses 10 and 60 described above are believed to be particularly advantageous when implemented in the fuse devices 112 shown in FIG. 3, although the invention shall not be limited solely to any particular application in the system 100 or otherwise. The advantages and benefits of the fuses 10 and 60 may be realized in other applications beyond the system 100 if desired.

One embodiment of a fuse element assembly for a current limiting fuse is disclosed herein. The fuse element assembly comprises first and second terminal elements, and at least one current limiting fuse element extending between the first and second terminal elements. The fuse element is connected to the first terminal element, and at least one resistance element is connected in series with the current limiting fuse element. The resistance element has a greater resistance than the current limiting fuse element, and the resistance element connected in series with the second terminal element.

Optionally, the fuse element assembly may further comprises an insulative form, with one of the current limiting fuse element and the resistance element being wound around the form. The current limiting fuse element may comprise a low current interrupting fuse element portion extending from the first end, and a high current limiting fuse element portion extending from the second end, with the low current interrupting fuse element portion and the high current limiting fuse element portion coupled to one another intermediate the first and second end. The resistance element may comprise a high resistance wire. The current limiting fuse element may have a first axial length, and the current limiting fuse element may have a varying cross sectional area along the axial length. Also, the resistance element may have a second axial length, and the resistance element may have a uniform cross sectional area along the axial length. The current limiting fuse element may be configured as a backup fuse element. The current limiting fuse element may be fabricated from a first material, and the resistance element may be fabricated from a second material different from the first material.

An embodiment of a fuse element assembly for a current limiting fuse is also disclosed herein. The fuse element assembly comprises an insulative form comprising opposite first and second ends, a first electrically conducting connector coupled to the form first end, a second electrically conducting connector coupled to the form second end, and a current limiting fuse element connected to the first connector. The current limiting fuse element is fabricated to include a plurality of weak spots configured for current limiting interruption of current, and a resistance element connected in series with the current limiting fuse element at a location between the first and second ends. The resistance element is separately fabricated from the current limiting fuse element and has different current interruption characteristics than the current limiting fuse element.

Optionally, the resistance element may extend helically around the insulative. An insulating sleeve may further be provided, and the sleeve may surround a portion of the current limiting fuse element. The current limiting fuse element may comprise a low current interrupting fuse element portion extending from the first end and a high current limiting fuse element portion extending from the second end, with the low current interrupting fuse element portion and the high current limiting fuse element portion coupled to one another intermediate the first and second end. The resistance element may comprise a high resistance wire. The resistance element may not include weak spots. The current limiting fuse element is configured as a backup fuse element. The current limiting fuse element may be fabricated from a first material, and the resistance element may be fabricated from a second material different from the first material.

An embodiment of a current limiting fuse is also disclosed. The fuse comprises a body comprising opposite first and second ends, a first end-cap coupled to the body first end, a second end-cap coupled to the body second end, and a fuse element assembly situated within the body and extending between the end-caps. The fuse element assembly comprises a first end connected to the first end cap and a current limiting fuse element extending away from the first end, and a resistance element connected in series with the current limiting fuse element and comprising a second end connected to the second end cap. The resistance element is fabricated to have a greater resistance than the current limiting fuse element.

Optionally, the current limiting element is configured as a full range fuse. Alternatively, the current limiting fuse may be configured as a backup fuse. An insulating form may be provided, with the resistance element being coiled around the form. The current limiting element may be fabricated from a first material, and the resistance element may be fabricated from a second material different from the first material. The resistance element is entirely located interior to the body, and the body may be tubular.

An embodiment of a full range fuse is disclosed. The fuse comprises a body comprising opposite first and second ends, first and second end-caps coupled to the first and second body ends, an insulating form extending interior to the body between the first and second body ends and a plurality of low current interrupting fuse elements coupled to one of the first and second end caps and extending toward the other of the first and second end-caps. The low current interrupting fuse elements are connected in parallel with one another, and a plurality of high current interrupting fuse elements are provided. Each of the plurality of the high current interrupting elements are connected in series to the respective low current interrupting elements, and a plurality of resistance elements are connected in series to the high current interrupting elements and electrically connected to the second end cap. Each of the high current interrupting elements, each of the low current interrupting elements, and each of the resistance elements are coiled around the form and are entirely enclosed within the body.

An embodiment of a power line communications carrier system is also disclosed. The system comprise a high voltage power line, a low voltage digital communications device, a coupling connecting the low voltage digital communications device to the high voltage power line, and a current limiting fuse connected between the coupling and the communications device, wherein the current limiting fuse has a resistance greater than about 0.5Ω.

Optionally, the current liming fuse has a resistance of greater than about 2.0Ω. The power line communications carrier system may be a broadband over power line system. The current limiting fuse may comprise at least one current limiting fuse element extending between the first and second terminal elements and at least one resistance element connected in series with the current limiting fuse element, with the resistance element having a greater resistance than the current limiting fuse element. The current limiting fuse element may comprise a low current interrupting fuse element portion extending from the first end, a high current limiting fuse element portion extending from the second end, and the low current interrupting fuse element portion and the high current limiting fuse element portion coupled to one another intermediate the first and second end. The resistance element may comprise a high resistance wire. The current limiting fuse element may have a first axial length, and the current limiting fuse element may have a varying cross sectional area along the axial length. The resistance element may have a second axial length, and the resistance element having a uniform cross sectional area along the axial length. The current limiting fuse element may be configured as a backup fuse element. The current limiting fuse element may be fabricated from a first material, and the resistance element may be fabricated from a second material different from the first material.

A method of protecting a circuit used to send digital data over a power line is also disclosed. The circuit includes a high voltage power line, a coupling coupled to the power line, and a low voltage digital communications device connected to the coupling. The method comprises providing a current limiting fuse having a resistance of at least 0.5Ω; and connecting the current limiting fuse between the digital communications device and the coupling.

Optionally, providing a current limiting fuse may include: providing a current limiting fuse element; connecting one end of the current limiting fuse element to fist terminal element; connecting a resistance element, separately fabricated from the fuse element, in series with the current limiting fuse element; and connecting one of the resistance element to a second terminal element, wherein a summed resistance of the fuse element and the resistance element is about 0.5Ω or more.

While the invention has been described in terms of various specific embodiments, those skilled in the art will recognize that the invention can be practiced with modification within the spirit and scope of the claims.

What is claimed is:

1. A fuse element assembly for a current limiting fuse, the fuse element assembly comprising:
first and second terminal elements
at least one current limiting fuse element extending between the first and second terminal elements, the fuse element connected to the first terminal element; and
at least one resistance element connected in series with the current limiting fuse element, the resistance element having a greater resistance than the current limiting fuse element, the resistance element connected in series with the second terminal element.

2. The fuse element assembly of claim 1, further comprising an insulative form, one of the current limiting fuse element and the resistance element being wound around the form.

3. The fuse element assembly of claim 1, wherein the at least one current limiting fuse element comprises a low current interrupting fuse element portion extending from the first end, a high current limiting fuse element portion extending from the second end, and the low current interrupting fuse element portion and the high current limiting fuse element portion coupled to one another intermediate the first and second end.

4. The fuse element assembly of claim 1, wherein the resistance element comprises a high resistance wire.

5. The fuse element assembly of claim 1, wherein the current limiting fuse element has a first axial length, the current limiting fuse element having a varying cross sectional area along the axial length; and
the resistance element having a second axial length, the resistance element having a uniform cross sectional area along the axial length.

6. The fuse element assembly of claim 1, wherein the current limiting fuse element is configured as a backup fuse element.

7. The fuse element assembly of claim 1, wherein the current limiting fuse element is fabricated from a first material, and the resistance element is fabricated from a second material different from the first material.

8. A fuse element assembly for a current limiting fuse, the fuse element assembly comprising:
an insulative form comprising opposite first and second ends;
a first electrically conducting connector coupled to the form first end;
a second electrically conducting connector coupled to the form second end;
a current limiting fuse element connected to the first connector, the current limiting fuse element fabricated to include a plurality of weak spots configured for current limiting interruption of current; and
a resistance element connected in series with the current limiting fuse element at a location between the first and second ends; the resistance element being separately fabricated from the current limiting fuse element and having different current interruption characteristics than the current limiting fuse element.

9. The fuse element assembly in accordance with claim 8, wherein the resistance element extends helically around the insulative form.

10. The fuse element assembly in accordance with claim 8, further comprising an insulating sleeve, the sleeve surrounding a portion of the current limiting fuse element.

11. The fuse element assembly of claim 8, wherein the current limiting fuse element comprises a low current interrupting fuse element portion extending from the first end, a high current limiting fuse element portion extending from the second end, and the low current interrupting fuse element portion and the high current limiting fuse element portion coupled to one another intermediate the first and second end.

12. The fuse element assembly of claim 8, wherein the resistance element comprises a high resistance wire.

13. The fuse element assembly of claim 8, wherein the resistance element does not include weak spots.

14. The fuse element assembly of claim 8, wherein the current limiting fuse element is configured as a backup fuse element.

15. The fuse element assembly of claim 8, wherein the current limiting fuse element is fabricated from a first material, and the resistance element is fabricated from a second material different from the first material.

16. A current limiting fuse comprising:
a body comprising opposite first and second ends;
a first end-cap coupled to the body first end;
a second end-cap coupled to the body second end; and
a fuse element assembly situated within the body and extending between the end-caps, the fuse element assembly comprising:
a first end connected to the first end cap and a current limiting fuse element extending away from the first end; and
a resistance element connected in series with the current limiting fuse element and comprising a second end connected to the second end cap, the resistance element fabricated to have a greater resistance than the current limiting fuse element.

17. The fuse of claim 16, wherein the current limiting element is configured as a full range fuse.

18. The fuse of claim 16, wherein the current limiting fuse is configured as a backup fuse.

19. The fuse of claim 16, further comprising an insulating form, the resistance element being coiled around the form.

20. The fuse of claim 16, wherein the current limiting element is fabricated from a first material, and the resistance element is fabricated from a second material different from the first material.

21. The fuse of claim 16, wherein the resistance element is entirely located interior to the body.

22. The fuse of claim 16, wherein the body is tubular.

23. A full range fuse comprising:
a body comprising opposite first and second ends;
first and second end-caps coupled to the first and second body ends;
an insulating form extending interior to the body between the first and second body ends;
a plurality of low current interrupting fuse elements coupled to one of the first and second end caps and extending toward the other of the first and second end-caps, the low current interrupting fuse elements connected in parallel with one another,
a plurality of high current interrupting fuse elements, each of the plurality of the high current interrupting elements connected in series to the respective low current interrupting elements; and
a plurality of resistance elements connected in series to the high current interrupting elements and electrically connected to the second end cap;
wherein each of the high current interrupting elements, each of the low current interrupting elements, and each of the resistance elements are coiled around the form and are entirely enclosed within the body.

24. A power line communications carrier system comprising:
a high voltage power line;
a low voltage digital communications device;
a coupling connecting the low voltage digital communications device to the high voltage power line; and
a current limiting fuse connected between the coupling and the communications device, wherein the current limiting fuse has a resistance greater than about 0.5Ω.

25. The system of claim 24, wherein the current liming fuse has a resistance of greater than about 2.0Ω.

26. The system of claim 24, wherein the power line communications carrier system is a broadband over power line system.

27. The system of claim 24, wherein the current limiting fuse comprises at least one current limiting fuse element extending between the first and second terminal elements and at least one resistance element connected in series with the current limiting fuse element, the resistance element having a greater resistance than the current limiting fuse element.

28. The system of claim 27, wherein the at least one current limiting fuse element comprises a low current interrupting fuse element portion extending from the first end, a high current limiting fuse element portion extending from the second end, and the low current interrupting fuse element portion and the high current limiting fuse element portion coupled to one another intermediate the first and second end.

29. The system of claim 27, wherein the resistance element comprises a high resistance wire.

30. The system of claim 27, wherein the current limiting fuse element has a first axial length, the current limiting fuse element having a varying cross sectional area along the axial length.

31. The system of claim 30, wherein the resistance element having a second axial length, the resistance element having a uniform cross sectional area along the axial length.

32. The system of claim 27, wherein the current limiting fuse element is configured as a backup fuse element.

33. The system of claim 27, wherein the current limiting fuse element is fabricated from a first material, and the resistance element is fabricated from a second material different from the first material.

34. A method of protecting a circuit used to send digital data over a power line, the circuit including a high voltage power line, a coupling coupled to the power line, and a low voltage digital communications device connected to the coupling, the method comprising:
providing a current limiting fuse having a resistance of at least 0.5Ω; and
connecting the current limiting fuse between the digital communications device and the coupling.

35. The method of claim 34, wherein providing a current limiting fuse comprises:
providing a current limiting fuse element;
connecting one end of the current limiting fuse element to fist terminal element;
connecting a resistance element, separately fabricated from the fuse element, in series with the current limiting fuse element; and
connecting the resistance element to a second terminal element, wherein a summed resistance of the fuse element and the resistance element is about 0.5Ω or more.
